(19) United States
(12) Patent Application Publication
(10) Pub. No.: US 2011/0261203 A1
(43) Pub. Date: Oct. 27, 2011

(54) IMAGING SCANNER UTILIZED AS A CCTV CAMERA

(75) Inventors: Dayaker Mupkala, Hyderabad (IN); Kishan Prasad, Hyderabad (IN)

(73) Assignee: Hand Held Products, Inc., Skaneateles Falls, NY (US)

(21) Appl. No.: 12/765,291

(22) Filed: Apr. 22, 2010

(51) Int. Cl. H04N 7/18

(52) U.S. Cl. 348/150; 348/143; 348/E07.085

(57) ABSTRACT

A method of operating an optical indicia reader adapted for reading information bearing indicia (IBI) information comprising the steps of: capturing images of a region of interest utilizing an image sensor; decoding IBIs in captured images when operating the reader in an indicia reading mode; transmitting captured images of the region of interest to a server periodically when operating the reader in a security mode; and, archiving the transmitted images.

### FIELD OF THE INVENTION

This application relates to indicia reading devices, and more particularly to an indicia reading device utilized as a CCTV camera.

### BACKGROUND

Indicia reading devices (also referred to as scanners, image reader, indicia readers, etc.) typically read data represented by printed or displayed information bearing indicia (IBI), (also referred to as symbols, symbology, bar codes, etc.) For instance one type of a symbol is an array of rectangular bars and spaces that are arranged in a specific way to represent elements of data in machine readable form. Indicia reading devices typically transmit light onto a symbol and receive light scattered and/or reflected back from a bar code symbol or indicia. The received light is interpreted by a processor which performs signal and/or image processing to extract the data represented by the symbol. Optical indicia reading devices typically utilize visible or infrared light. Laser indicia reading devices typically utilize transmitted laser light.

One-dimensional (1D) optical bar code readers are characterized by reading data that is encoded along a single axis, in the widths of bars and spaces, so that such symbols may be read from a single scan along that axis, provided that the symbol is sampled with a sufficiently high resolution along that axis.

In order to allow the encoding of larger amounts of data in a single bar code symbol, a number of 1D stacked bar code symbologies have been developed which partition encoded data into multiple rows, each including a respective 1D bar code pattern, some or all of which must be scanned and decoded, then linked together to form a complete message. Scanning still requires relatively higher resolution in one dimension only, but multiple linear scans at different locations on a second dimension are needed to read the whole symbol.

A class of bar code symbologies known as two dimensional (2D) matrix symbologies have been developed which require image based reading and offer greater data densities and capacities than 1D symbologies. 2D matrix codes encode data as dark or light data elements within a regular polygonal matrix, accompanied by graphical finder, orientation and reference structures.

Often times an optical reader may be portable and wireless in nature thereby providing added flexibility. In these circumstances, such readers form part of a wireless network in which data collected within the terminals is communicated to a host computer situated on a hardwired backbone via a wireless link. For example, the readers may include a radio or optical transceiver for communicating with a remote computer.

Some data collection devices, such as hand-held indicia readers, are capable of capturing images as well as reading barcodes. The reading and decoding of a barcode represents an operation distinct from that involved in capturing an image. The reading and decoding of a bar code involves the imaging and then decoding of a one or two dimensional graphic symbol into the alphanumeric, full ASCII or other data sequence encoded by the symbol. The capturing of an image involves storing an electronic visual copy/representation of the image.

A platform that may be utilized to house and indicia reader is a optical indicia reader. Optical indicia readers (also referred to as smart phones, handheld devices, handheld computers, PDAs, PDTs, etc.) are widely used worldwide, and may be described as pocket-sized computing devices, typically having a display screen with touch input or a miniature keypad. In some optical indicia readers the input and output are combined into a touch-screen interface. Optical indicia readers are popular because they provide the assistance and convenience of a conventional computer (laptop, notebook or otherwise) in environments where carrying one would not be practical. Enterprise digital assistants further extend the available functionality of optical indicia readers.

An Enterprise digital assistant (EDA) is a handheld computer adapted for usage with SME (Small to Medium Enterprise) and Enterprise business Application software|Applications as a data capture optical indicia reader. Such data capture applications include indicia readers, biometrics, magnetic stripe, smart card and RFID data capture technologies used within communication networks such as WLANs (Wireless Local Area Networks), Bluetooth, Wide area network|WAN/LAN/Personal Area Network|PAN voice and data communications, VOIP and GPRS Edge Communications.

Efforts regarding such systems have led to continuing developments to improve their versatility, practicality and efficiency.

### BRIEF DESCRIPTION OF THE DRAWINGS

FIG. 1 is a block diagram of an exemplary optical indicia reader system.

FIG. 2 is a block schematic diagram of an exemplary optical indicia reader.

FIG. 3 is a fragmentary partially cutaway side view of an exemplary indicia reader.

FIG. 4 is a block diagram of an exemplary optical indicia reader system.

FIG. 5 is a block diagram of an exemplary optical indicia reader system.

### DETAILED DESCRIPTION

Reference will now be made to exemplary embodiments which are illustrated in the accompanying drawings. Other embodiments may be in various forms and the exemplary embodiments should not be construed as limited to the embodiments set forth herein. Rather, these representative embodiments are described in detail so that this disclosure will be thorough and complete, and will fully convey the scope, structure, operation, functionality, and potential applicability to those skilled in the art. Wherever possible, the same reference numbers will be used throughout the drawings to refer to the same or like parts. The term “scan” or “scanning” used herein refers to reading or extracting data from an information bearing indicia (or symbol). The term imaging used herein refers to the taking or creation of an electronic image.

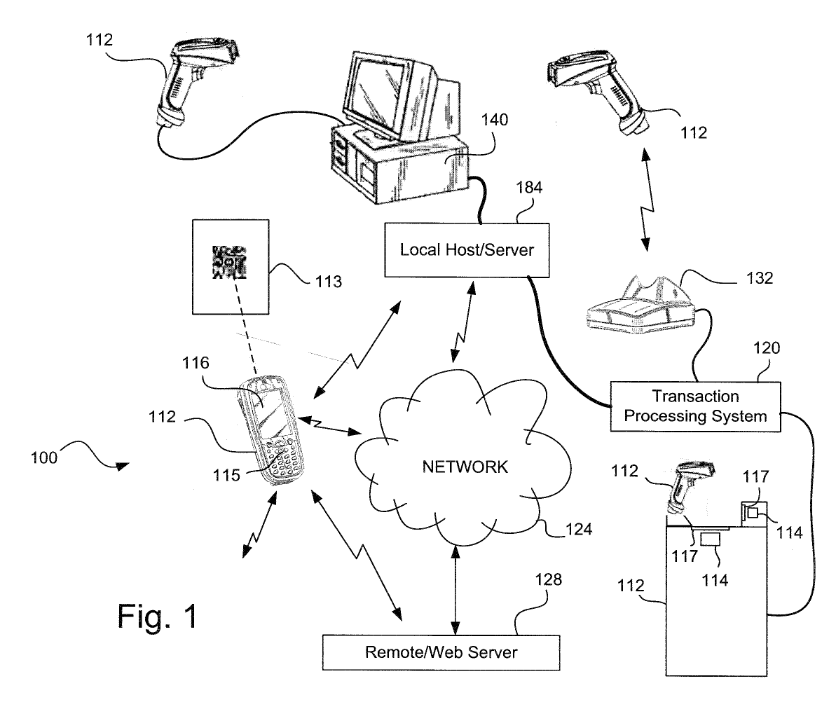

FIG. 1 illustrates an exemplary optical indicia reader system 100 configuration, wherein a plurality of optical indicia readers 112 are being operated or utilized which may be in communication (wired or wireless) with other optical indicia readers 112, a local host/sever 184, a point of transaction processing system 140, a network 120, a remote/web server 128, a base unit 138 or other systems and devices having communication capabilities. The optical indicia reader system 100 may be in communication directly with each other or indirectly through other devices, networks, servers or systems.

The optical indicia readers 112 are utilized where information bearing indicia (IBI) are present. The indicia readers may be stationary or hand-held and may be optical indicia reading devices utilizing image capturing.

Exemplary optical indicia readers 112 may be a hand held scanner, a portable data terminal (PDT), personal digital assistant (PDA), mobile phone, mobile device, etc. A Portable Data Terminal, or PDT, is typically an electronic device that is used to enter or retrieve data via wireless transmission (Bluetooth, WLAN or WWAN) and may also serve as an indicia reader used in stores, warehouse, hospital, or in the field to access a database from a remote location. Personal Digital Assistants (PDAs) are handheld devices typically used as a personal organizer, and may have many uses such as calculating, use as a clock and calendar, playing computer games, accessing the Internet, sending and receiving E-mails, use as a radio or stereo, video recording, recording notes, use as an address book, and use as a spreadsheet.

The optical indicia readers may be operated or utilized in a remote location, such as in an establishment, a store point of transaction (POT), a warehouse, a delivery truck, in the field, etc. Distances for communications from the optical indicia reader may be short (a few meters as in television remote control) or very long (thousands or even millions of kilometers for radio communications). Wireless communication may involve radio frequency communication and may involve point-to-point communication, point-to-multipoint communication, broadcasting, cellular networks and other wireless networks. This may involve: cordless telephony such as DECT (Digital Enhanced Cordless Telecommunications); Cellular systems such as 0G, 1G, 2G, 3G or 4G; Short-range point-to-point communication such as IrDA or RFID (Radio Frequency Identification), Wireless USB, DSRC (Dedicated Short Range Communications); Wireless sensor networks such as ZigBee; Personal area networks such as Bluetooth or Ultra-wideband (UWB from WiMedia Alliance); Wireless computer networks such as Wireless Local Area Networks (WLAN), IEEE 802.11 branded as WiFi or HIPERLAN; or Wireless Metropolitan Area Networks (WMAN) and Broadband Fixed Access (BWA) such as LMDS, WiMAX or HIPERMAN.

Optical indicia readers may be utilized as part of Mobile Enterprise (Mobile ERP), which is a collection of Online Interactive Business Applications such as SMS and E-mail. Business modules, functions and operations executed using Mobile Enterprise include Collaboration, Document management system (DMS), Customer relationship management (CRM), Point of sale (POS), Human resource management systems (HRMS), Accounting software, Enterprise resource planning (ERP), including sales order, sourcing, tender, request for Quotation, purchase order, shipment, receiving, warehousing, inventory control, delivery order, invoicing, customer service order, production monitoring and control, work order, as well as basic utilities such as corporate calendar, corporate address book, corporate bulletin board, notes and internal messaging.

Mobile Enterprise (Mobile ERP) devices require manual data entry for various applications. The manual data entry can be labor intensive and requires the user to be very precise when entering the data.

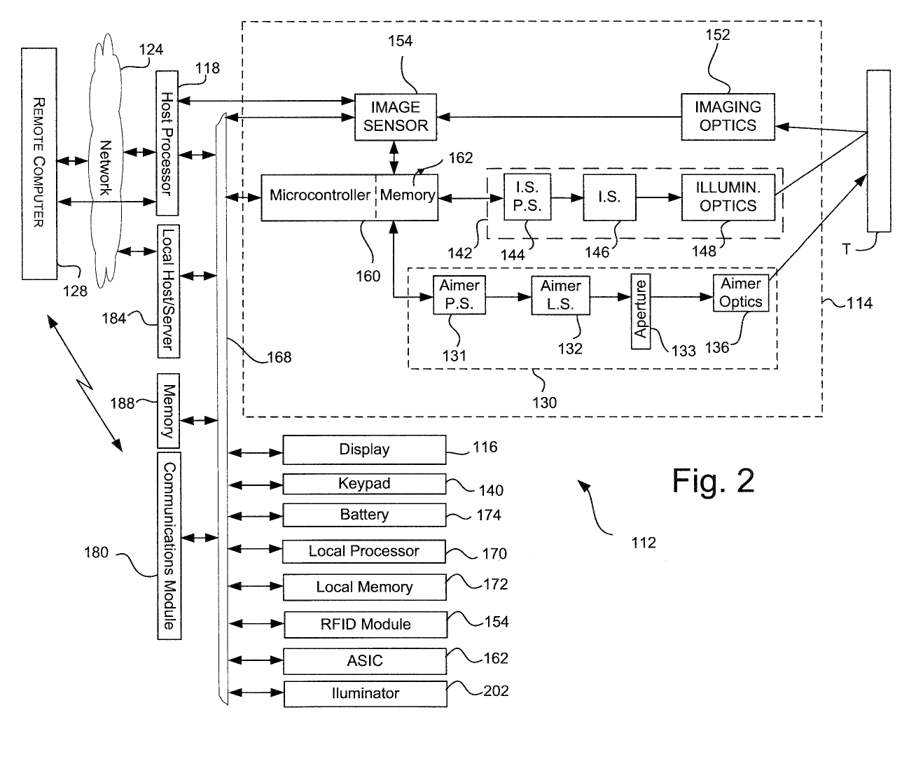

Referring to FIG. 2, a optical indicia reader 112 may have a plurality of exemplary subsystems or components provided within a housing including an indicia reading assembly 114, a RFID module 154, an illuminator 202, local processor 170, an ASIC 162, local memory 172, a battery 174, a display 116, a key pad 140, a communications module 180 which may communicate via one or more bus 168, data lines or other signal or data communication form. The optical indicia reader may communicate with a host processor 118, a local host/server 184, host memory 188, network 124 or remote server 128. Communications module 180 provides a communication link from imaging reader 114 to other imaging readers or to other systems such as a server/remote processor 124.

An exemplary indicia reading assembly 114 may have a number of subsystems for capturing and reading images, some of which may have symbol indicia provided therein. Indicia reader assembly 114 may have imaging receive optics 152 for receiving light reflected from a target T or region of interest (ROI) and directing or projecting the reflected light from the target T to an image sensor 154.

The receive optics 152 has a focal point wherein parallel rays of light coming from infinity converge at the focal point. If the focal point is coincident with the image sensor, the target (at infinity) is “in focus”. A target T is said to be in focus if light from target points are converged about as well as desirable at the image sensor. Conversely, it is out of focus if light is not well converged. “Focusing” is the procedure of adjusting the distance between the receive optics and the image sensor to cause the target T to be approximately in focus. The target may be any object or substrate and may be an information bearing indicia, text or other machine readable indicia.

Image sensor 154 may be a one or two-dimensional array of pixels adapted or configured to operate in a rolling shutter, global shutter or full frame operating mode which is a color or monochrome 2D CCD, CMOS, NMOS, PMOS, CID, CMD, etc. solid state image sensor. This sensor contains an array of light sensitive photodiodes (or pixels) that convert incident light energy into electric charge. Solid state image sensors allow regions of a full frame of image data to be addressed.

In a full frame (or global) shutter operating mode, the entire imager is reset before integration to remove any residual signal in the photodiodes. The photodiodes (pixels) then accumulate charge for some period of time (exposure period), with the light collection starting and ending at about the same time for all pixels. At the end of the integration period (time during which light is collected), all charges are simultaneously transferred to light shielded areas of the sensor. The light shield prevents further accumulation of charge during the readout process. The signals are then shifted out of the light shielded areas of the sensor and read out.

An exemplary sensor 154 may be a back-illuminated sensor. In a back-illuminated back-illuminated image sensor an incident light beam is irradiated to the back face of a chip opposite to the other face or surface of the chip on which electrodes and the like are disposed. The back-illuminated image sensor is provided with a light converting portion for each pixel on the back face side of the chip, and it is provided with portions for processing signal charges (charge processing portions) in some way, such as an A/D converter and a signal storage portion on the surface side of the chip. If visible light is the incident beam, the pixels are photoelectric cells or photodiodes.

The output of the image sensor may be processed utilizing one or more functions or algorithms to condition the signal appropriately for use in further processing downstream, including being digitized to provide a digitized image of target T. Digitizing or digitization may be representing an object, an image, or a signal (usually an analog signal) by a discrete set of its points or samples. The result is called “digital representation” or, more specifically, a “digital image”, for the object, and “digital form”, for the signal. Digitization may be performed by reading an analog signal A, and, at regular time intervals (sampling frequency), representing the value of A at that point by an integer. Each such reading is called a sample.

A microcontroller 160 may perform a number of processing functions and be located on board with other components, such as the image sensor. The particulars of the functionality of microcontroller 160 may be determined by or based upon certain configuration settings or data which may be stored in firmware, remote 166 or local memory 162, 172. Exemplary functions of microcontroller 160 may be controlling the amount of illumination provided by an illumination source 146 by controlling the output power provided by illumination source power supply 144 and controlling an aiming pattern generator 130. Microcontroller 160 may also control other functions and devices.

An exemplary microcontroller 160 is a mixed-signal array with on-chip controller devices designed to replace multiple traditional MCU-based system components with one single-chip programmable device. It may include configurable blocks of analog and digital logic, as well as programmable interconnects.

Microcontroller 160 may include a predetermined amount of memory 162 for storing firmware and data. The firmware may be a software program or set of instructions embedded in or programmed on the microcontroller which provides the necessary instructions for how the microcontroller operates and communicates with other hardware. The firmware may be stored in the flash memory (ROM) of the microcontroller as a binary image file and may be erased and rewritten. The firmware may be considered “semi-permanent” since it remains the same unless it is updated. This firmware update or load may be handled by a device driver.

The components in reader 114 may be connected by one or more bus 168, data lines or other signal or data communication form. Exemplary forms may be an Inter-IC bus such as a two wire interface (TWI), dedicated data bus, RS232 interface, USB, RS485, RS423, RS422, etc.

A TWI bus is a control bus that provides a communications link between integrated circuits in a system. This bus may connect to a host computer in relatively close proximity, on or off the same printed circuit board as used by the imaging device. TWI is a two-wire serial bus with a software-defined protocol and may be used to link such diverse components as the image sensor 154, temperature sensors, voltage level translators, EEPROMs, general-purpose I/O, ND and D/A converters, CODECs, and microprocessors/microcontrollers.

Host processor 118 or local or on board processor 170 may be utilized to perform a number of functional operations, which may involve the performance of a number of related steps, the particulars of which may be determined by or based upon certain configuration settings stored in firmware or memory 166 which may be any one of a number of memory types such as RAM, ROM, EEPROM, etc. In addition some memory functions may be stored in memory 162 provided as part of the microcontroller 160.

An exemplary function of a processor 118, 170 may be to decode machine readable symbology provided within the target or captured image. One dimensional symbologies may include very large to ultra-small, Code 128, Interleaved 2 of 5, Codabar, Code 93, Code 11, Code 39, UPC, EAN, MSI, or other 1D symbologies. Stacked 1D symbologies may include PDF, Code 16K, Code 49, or other stacked 1D symbologies. 2D symbologies may include Aztec, Datamatrix, Maxicode, QR-code, or other 2D symbologies. UPC/EAN bar codes are used as the standard to mark retail products throughout North America, Europe and several other countries throughout the worlds. Decoding is a term used to describe the interpretation of a machine readable code contained in an image projected on the image sensor 154. The code has data or information encoded therein. Information respecting various reference decode algorithm is available from various published standards, such as by the International Standards Organization (“ISO”).

Another exemplary function of processor 118, 170 may be to perform image processing functions on captured images. Image processing may be any form of signal processing for which the input is an image or frames of video. The output of image processing may be either an image or a set of characteristics or parameters related to the image. Image processing techniques may involve treating the image as a two dimensional signal and applying specific signal processing techniques to it, such as predetermined feature detection, activity detection or remote sensing.

Feature detection may be one or more methods for computing abstractions of image information and making decisions at image pixels or points whether there is an image feature of a given type at those points. The resulting features may be subsets of the image domain, often in the form of isolated points, continuous curves or connected regions. A feature may be defined as an interesting part of an image and may be used as a starting point for processor vision algorithms.

Feature detection may search for features in only certain parts of an image.

Remote sensing may be described as the small or large scale acquisition of information of an image, object or phenomenon, by the use of recording or real-time sensing device(s) not in physical or intimate contact with a region of interest.

Aiming pattern generator 130 may include a power supply 131, light source 132, aperture 133 and optics 136 to create an aiming light pattern projected on or near the target which spans a portion of the receive optical system 152 operational field of view with the intent of assisting the operator to properly aim the scanner at the bar code pattern that is to be read. A number of representative generated aiming patterns are possible and not limited to any particular pattern or type of pattern, such as any combination of rectilinear, linear, circular, elliptical, etc. figures, whether continuous or discontinuous, i.e., defined by sets of discrete dots, dashes and the like.

Generally, the aiming light source may comprise any light source which is sufficiently small or concise and bright to provide a desired illumination pattern at the target. For example, light source 132 for aiming generator 130 may comprise one or more LEDs.

The light beam from the LEDs 132 may be directed towards an aperture 133 located in close proximity to the LEDs. An image of this back illuminated aperture 133 may then be projected out towards the target location with a lens 136. Lens 136 may be a spherically symmetric lens, an aspheric lens, a cylindrical lens or an anamorphic lens with two different radii of curvature on their orthogonal lens axis. Alternately, the aimer pattern generator may be a laser pattern generator.

The light sources 132 may also be comprised of one or more laser diodes. In this case a laser collimation lens (not shown in these drawings) will focus the laser light to a spot generally forward of the scanning hear and approximately at the plane of the target T. This beam may then be imaged through a diffractive interference pattern generating element, such as a holographic element fabricated with the desired pattern in mind.

Indicia reader may include an illumination assembly 142 for illuminating target area T. Illumination assembly 142 may also include one or more power supplies 144, illumination sources 146 and illumination optics 148.

Illumination and aiming light sources with different colors may be employed. For example, in one such embodiment the indicia reader may include white and red LEDs, red and green LEDs, white, red, and green LEDs, or some other combination chosen in response to, for example, the color of the symbols most commonly imaged by the indicia reader. Different colored LEDs may be each alternatively pulsed at a level in accordance with an overall power budget.

An exemplary image sensor 154 may read images with illumination from a source other than illumination source 146, such as by an illuminator 202 or illumination from a source located remote from the reader, such as ambient light.

Processor, memory and associated circuitry which perform or control the exemplary image capture and decoding functions may be provided in the indicia reader assembly 114 or on associated circuit boards which are located within the housing of the optical indicia reader 112.

Exemplary functions of a processor or processors 118, 170 may be to facilitate operation of the image capture function, decoding functions, and operator interface functions. Operating software may be utilized to operate the processor for such functions seemingly simultaneously or in a multitasking role. An exemplary image reader operating software architecture may be organized into processes or threads of execution.

Operation of the decoding, which may be executed in a user or factory selectable relationship to a scanning routine, may be governed by parameters or configuration settings which are enabled for processing as a part of an autodiscrimination process, whether decoding is to be continuous or discontinuous, etc. Permitted combinations of scanning and decoding parameters together define the scanning-decoding relationships or modes which the reader will use. In the continuous mode (also referred to as continuous scanning mode, continuous streaming mode, streaming mode, fly-by scanning mode, on the fly scanning mode or presentation mode) the reader is held in a stationary manner and targets (such as symbols located on packages) are passed by the reader 112. In the continuous mode, the reader takes continuous image exposures seriatim and continuously decodes or attempts to decode some or all of these images. In the continuous mode exposure times and decoding times may be limited.

In an exemplary embodiment the reader 112 may operate in the continuous mode by taking image exposure seriatim or continuously without decoding to thereby operate in a video recording type mode.

Discontinuous mode is a mode wherein scanning and/or decoding stops or is interrupted and initiated with an actuation event, such as pulling or pushing of a trigger or button, (115, 315) to restart. An exemplary utilization of the reader in discontinuous mode is via hand held operation. While triggered, the image reader may expose images continuously and decode images continuously. Decoding stops once the image reader is no longer triggered. Exposing of images however, may continue. In the discontinuous mode, the exposure time, decoding time out limits and decoding aggressiveness may be increased more than those set for continuous mode by utilizing a different decoding algorithm. The discontinuous mode is typically initiated because the operator knows a symbol is present. The decoder therefore may forego making a determination of the presence of a symbol because a symbol is presumed to be in the field of view. Discontinuous mode may provide longer range scanning than the continuous mode.

Switching between continuous and discontinuous modes may be accomplished by use of a trigger located on the reader. For example, when the trigger is depressed by an operator the reader may operate in a discontinuous mode and when the trigger is released the reader may switch to continuous mode after a predetermined period of time. A scanning subroutine may specify an address buffer space or spaces in which scan data is stored and whether scanning is to be continuous or discontinuous. Another example of switching between continuous and discontinuous modes may be accomplished by symbology wherein switching between the modes depends on the type of symbology detected. The reader may stop attempting to decode a symbol after a predetermined time limit. The reader may limit the type of symbols to decode when in the continuous mode.

The aiming pattern generator 130 may be programmed to operate in either continuous or discontinuous modes.

In the continuous mode, an exemplary optical indicia reader may be configured to automatically switch to a reduced power state if no symbol has been sensed for a period of time. Upon sensing of a symbol the scanner may then automatically switch back to the higher power state continuous mode. In this reduced power state the scanner may change from having the aimer and/or illumination light sources on for every scan to having either/or on for only some of the scans (e.g. every 2 or 3 or less scans). In this manner the system may still be in a position to sense the presence of a symbol, but will draw less current and also generate less internal heating. After sensing a symbol, the image reader may utilize aiming/illumination for every scan until another period of inactivity is sensed. Mode changes may be accomplished by the host computer in response to an appropriate signal over either a direct connection or wireless connection to the scanner.

Exemplary indicia readers may use the aforementioned memory or firmware flash memory to store certain reader settings or reader configuration settings. Exemplary configuration settings may be pre-defined bar code output data based on the scan input.

Other exemplary configuration settings may be settings that affect the functional operation of the host processor or microcontroller, such as a scanning subroutine which specifies the address buffer space or spaces in which scan data will be stored and whether scanning is to be continuous (e.g., at a full video rate, such as 30 frames per second), or discontinuous (e.g., with pauses related to the current state of the trigger). The operation of the decoding routine, which is executed in a user or factory selectable relationship to the scanning routine, is governed by configuration settings which control the codes which are enabled for processing as a part of an autodiscrimination process, whether decoding is to be continuous or discontinuous, etc. Exemplary combinations of scanning and decoding configuration settings together define the scanning-decoding relationships or modes which the reader will use.

Other exemplary configuration settings may be aiming pattern center coordinates or position in order to decode the symbol that is closest to the aiming center parameter, or the symbol that is in some position relative to the aiming center.

Other exemplary configuration settings may be optical reader configuration, aimer configuration, number of pixels in the image to be used for initializing buffers, engine orientation, field illumination which may be defined as a profile saved as a function of radius from the imager optical centerline, information regarding lens distortions across the active image field, image distortion, dead or bad pixel, or image sensor noise corrections within the image processing algorithm.

Other exemplary configuration settings may be max LED current, receiving lens prescription or parameters functionally related thereto, laser diode aiming system power output or operating current or a parameter related thereto.

Other exemplary configuration settings may be indicia reader capabilities, such as whether the imager is enabled for image capture, what type of decoder level is enabled, or what types of symbology decoding is enabled.

Other examples of configuration settings are aiming pattern operation; field illumination; lens distortion; optical reader orientation; optical reader configuration; aimer configuration; software control, sales tracking or warranty tracking, indicia reader capabilities, such as whether the imager is enabled for image capture, what type of decoder level is enabled, or what types of symbology decoding is enabled, different methods of optical indicia reader control, or different methods of decoding, or different methods of displaying and saving images, etc.

Some of the configuration settings may be non-default configuration settings. A non-default configuration setting is a configuration setting that is not part of standard software/firmware provided by a reader manufacturer. Non-default configuration settings may be unique to a particular reader, a particular image engine, a particular establishment having multiple readers, a particular enterprise having multiple establishments having one or more readers, etc.

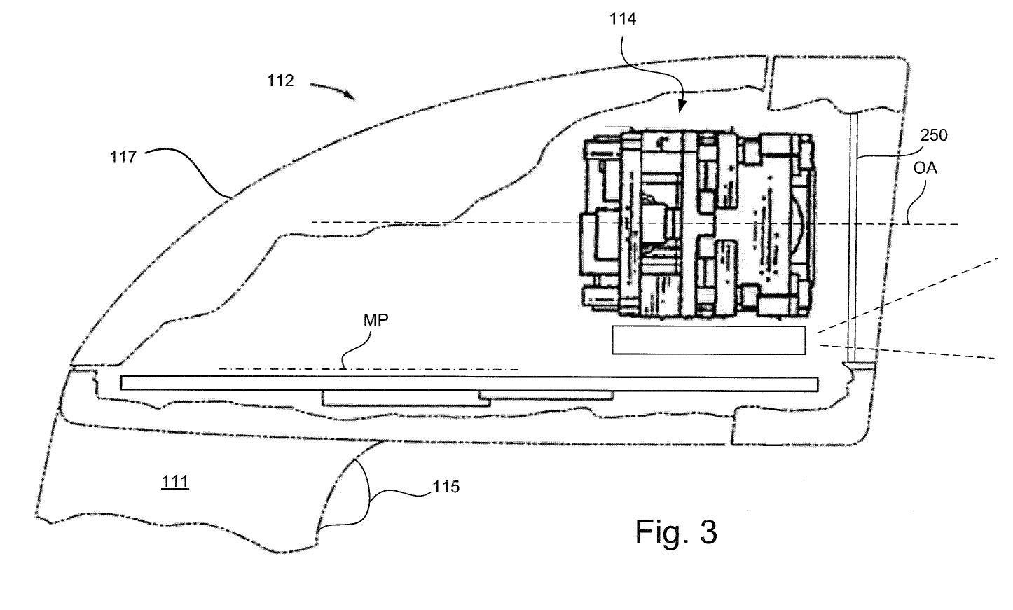

FIG. 3 illustrates an exemplary optical indicia reader 112 having an indicia reader assembly 114 and an illuminator 202 contained within a housing 117 designed, contoured or adapted for hand held operation. The indicia reader and illuminator transmit and/or receive light through a protective transparent window 250. What is meant by hand held operation is that the optical indicia reader can be easily grasped and held by a user. The optical indicia reader is a light-weight, truly portable device with a housing that is shaped so as to fit comfortably into a human hand and can be easily held and carried about without tiring the user. A button 115 may be utilized to control functions of the optical indicia reader, such as indicia reading.

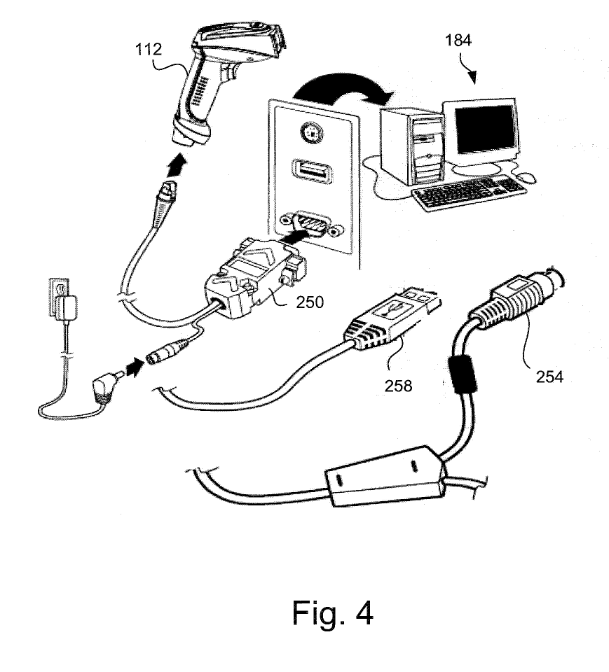

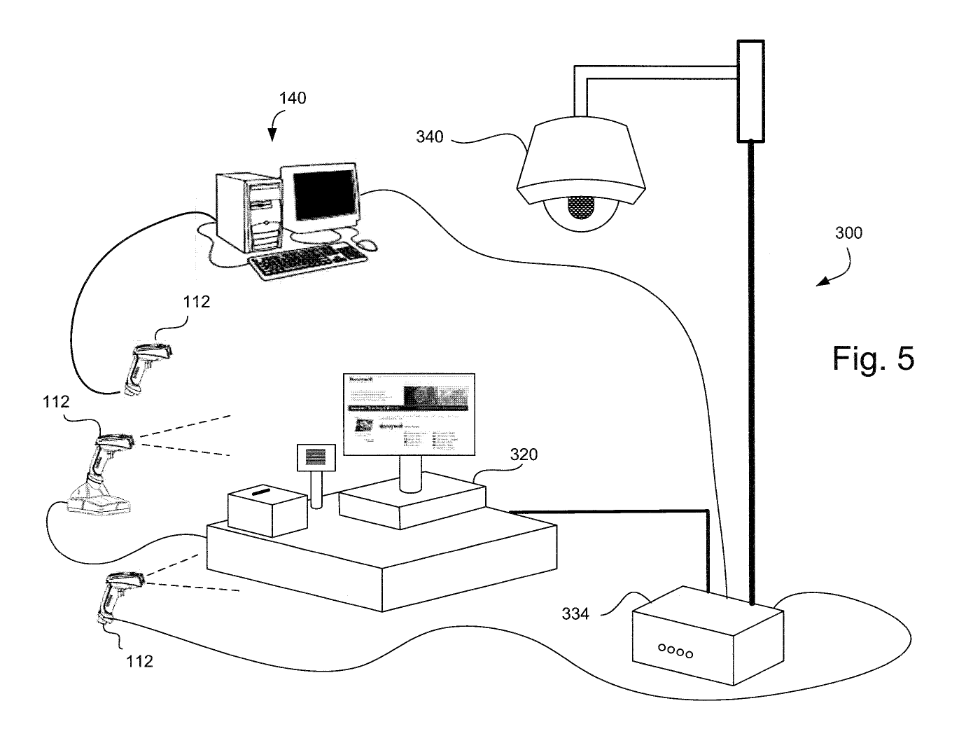

In exemplary embodiments shown in FIGS. 4 and 5, an optical indicia reader 112 may be in communication with an establishment host processor or server 184, 140, a point of transaction terminal or processor 320 or a security system server or processor 334 utilizing a Serial/USB/key board wedge cable 250, a serial to Ethernet converting device 254 or a USB to Ethernet converting device 258. In another exemplary embodiment the reader may transmit data wirelessly.

In an exemplary embodiment illustrated in FIG. 5, an optical indicia reader system 300 has optical indicia readers 112 that may be used for a CCTV (Closed Circuit Television) application to provide security in an establishment, such as at a POT. Optical indicia readers may be left idle during non-business hours or otherwise when not in use. When an optical indicia reader is not in use reading IBIs, it can configured to automatically capture continuous or periodic images. The captured images may then be utilized for security purposes. For example, an optical indicia reader may be pointed so that a region of interest such as a POT terminal is within the field of view (FOV) of the imager 114 of the reader. To facilitate this, the reader may be placed in a base 132 or stand.

An exemplary use of the exemplary optical reader is as the primary or sole scanner at a customer point of transaction (POT) in an establishment. Primary may mean the scanner at a POT is used to scan or image items more often than any other scanner or imager at the POT. A transaction may be any of a number of events that occur between a customer and an establishment, such as a store. The events may involve such things as exchange of monetary funds, payment for merchandise or service, return of merchandise, picking up merchandise that has already been paid for, or contracting for a service (such as leasing or renting).

As the primary scanner, merchandise with indicia can be read by it so that data decoded therefrom. In an exemplary embodiment, the reader may be configured to capture and send images to the POT terminal at regular time intervals during idle times, allowing the establishment to archive pictures or images for use at a later time. For example, archiving may be for security purposes.

In an exemplary embodiment the reader may be configured to send captured images to a POT terminal 320. The images may then be transferred by the POT terminal 320 to a local host server or processor for usage such as archiving, processing, etc. In an exemplary embodiment the images are archived or stored in memory or on a recording medium, such as a digital video recorder (DVR). In an exemplary embodiment the reader may be configured to send captured images directly to a local host server or processor to be archived.

In an exemplary embodiment, captured images may be archived and/or processed in the reader. Processing of captured images may comprise triggering a video surveillance system to have remote cameras focused and/or recording.

In an exemplary embodiment, the reader may be utilized to signal or alert a video surveillance system (VSS) 330. The VSS may then start recording surveillance video or images in the region of interest the reader was imaging. The VSS may also start storing images captured by the reader.

In an exemplary embodiment the reader processes captured images to detect a change in region of interest, such as motion of an object. If there is a change detected, the reader may be utilized to signal one or more security cameras near or nearest the region of interest. For example, a video surveillance server may be alerted to focus on an area where a predetermined activity or scene change is detected. A video surveillance server 334 may control one or more PTZ cameras 340 and/or fixed cameras to record video based on certain events. In an exemplary embodiment PTZ cameras may be running according to preset tours and an indicia reader may be used as an alerting mechanism to run them.

In an exemplary embodiment the indicia reader captures images within it's field of view and sends them to the video surveillance server periodically. The server may process these images, alert PTZ cameras to set their focus to the respective reader's field of view and start recording. In an exemplary embodiment, location information is transmitted from either the reader 112 or the POT server 320 to the video surveillance server 334 which may trigger the nearest camera to focus on the region of interest and the video surveillance server records events in the region of interest.

In an exemplary embodiment the indicia reader may support video analysis and perform the processing of images. The indicia reader may have enough memory to store the images.

In an exemplary embodiment the indicia reader sends captured images to a POT server or video surveillance server for video analysis using appropriate software algorithms.

An exemplary indicia reader may adjust security camera parameters, such as exposure, iris, focus or other settings based on conditions it detects such as ambient lighting conditions.

An exemplary indicia reader may be used as a standalone alerting device. For example the indicia reader may capture and store images of a region of interest after a detected security event and alert or notify establishment personnel with an audible or visual signal emanating from the indicia reader. A security event may be such things as motion or movement in the region of interest, displacement of objects in the region of interest, etc.

In an exemplary embodiment an indicia reader may detect an event in a region of interest and transmit location information to a security system.

An exemplary method of operating an optical indicia reader adapted for reading information bearing indicia (IBI) information comprises the steps of: capturing images of a region of interest utilizing an image sensor; decoding IBIs in captured images when operating the reader in an indicia reading mode; transmitting captured images of the region of interest to a server periodically when operating the reader in a security mode; and, archiving the transmitted images.

An exemplary method of operating an optical indicia reader adapted for reading information bearing indicia (IBI) information comprises the steps of:

capturing images of a region of interest utilizing an image sensor; decoding IBIs in captured images when operating the reader in an indicia reading mode; capturing images when operating the reader in a security mode of the region of interest when a security event is detected by the reader; storing the captured images; and, notifying personnel of the detection of the security event.

It should be understood that the programs, processes, methods and apparatus described herein are not related or limited to any particular type of computer or network apparatus (hardware or software). Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa. The described embodiments are exemplary only, and should not be taken as limiting the scope of the present invention. For example, the steps of the flow diagrams may be taken in sequences other than those described, and more, fewer or other elements may be used in the block diagrams. Also, unless applicants have expressly disavowed any subject matter within this application, no particular embodiment or subject matter is considered to be disavowed herein.

The claims should not be read as limited to the described order or elements unless stated to that effect. In addition, use of the term “means” in any claim is intended to invoke 35 U.S.C. §112, paragraph 6, and any claim without the word “means” is not so intended. Therefore, all embodiments that come within the scope and spirit of the following claims and equivalents thereto are claimed as the invention.

1. A method of operating a hand held optical indicia reader adapted for reading information bearing indicia (IBI) information comprising the steps of:
capturing images of a region of interest utilizing an image sensor;
decoding IBIs in captured images when operating the reader in an indicia reading mode;
processing captured images to detect predetermined activity or features;
transmitting captured images of the region of interest to a server periodically when operating the reader in a security mode; and,
archiving the transmitted images.

2. A method of operating an optical indicia reader in accordance with claim 1, wherein transmitting captured images occurs automatically when the predetermined activity or features are detected.

3. A method of operating an optical indicia reader in accordance with claim 1, further comprising the step of signaling a video surveillance system to begin recording events in the region of interest when the predetermined activity or features are detected.

4. A method of operating an optical indicia reader in accordance with claim 1, further comprising the step of signaling a video surveillance system to begin recording events with a security camera near the region of interest when the predetermined activity or features are detected.

5. A method of operating an optical indicia reader in accordance with claim 1, further comprising the step of signaling a video surveillance system to begin recording events with a security camera near the region of interest when motion in the field of view of the reader is detected.

6. A method of operating an optical indicia reader in accordance with claim 1, wherein the server is at least one of the following: a POT terminal; an establishment host server; and a security system server.

7. A method of operating an optical indicia reader in accordance with claim 1, further comprising the steps of:
signaling a video surveillance system to begin recording events in the region of interest when the predetermined activity or features are detected; and
adjusting security camera parameters based on the predetermined activity or features detected by the reader.

8. A method of operating an optical indicia reader in accordance with claim 1, further comprising the step of transmitting location information to a security system.

9. A method of operating an optical indicia reader adapted for reading information bearing indicia (IBI) information comprising the steps of:
capturing images of a region of interest utilizing an image sensor;
decoding IBIs in captured images when operating the reader in an indicia reading mode;
capturing images when operating the reader in a security mode of the region of interest when a security event is detected by the reader;
storing the captured images; and,
notifying personnel of the detection of the security event.

10. A method of operating an optical indicia reader in accordance with claim 9, further comprising the step of signaling a video surveillance system to begin recording events in the region of interest when the security event is detected.

11. A method of operating an optical indicia reader in accordance with claim 9, further comprising the step of signaling a video surveillance system to begin recording events with a security camera near the region of interest when the security event is detected.

12. A method of operating an optical indicia reader in accordance with claim 9, wherein the region of interest is a POT terminal.

13. A method of operating an optical indicia reader in accordance with claim 9, further comprising the steps of:
signaling a video surveillance system to begin recording events in the region of interest when the predetermined activity or features are detected; and
adjusting security camera parameters based on conditions detected by the reader.

14. A method of operating an optical indicia reader in accordance with claim 9, further comprising the step of transmitting location information to a security system.

15. An optical indicia reader adapted for reading information bearing indicia (IBI) information comprising:
an image sensor for capturing images of a region of interest;
a processor for decoding IBIs in captured images when operating the reader in an indicia reading mode;
a communication module for transmitting captured images of the region of interest to a server periodically when the processor is operating the reader in a security mode; and,
memory for archiving the transmitted images.

16. An optical indicia reader in accordance with claim 15, wherein transmitting captured images occurs automatically when predetermined activity or features are detected by the reader.

17. A method of operating an optical indicia reader in accordance with claim 15, wherein the communication module sends a signal to a video surveillance system to begin recording events in the region of interest when the predetermined activity or features are detected.

18. An optical indicia reader in accordance with claim 1, wherein the server is at least one of the following: a POT terminal; an establishment host server; and a security system server.
